(19) United States
(12) Patent Application Publication
(10) Pub. No.: US 2016/0199262 A1
(43) Pub. Date: Jul. 14, 2016

(54) Bottle Teat

(71) Applicant: MAPA GmbH, Zeven (DE)

(72) Inventor: Eckhard Itzek, Gyhum-Nartum (DE)

(73) Assignee: MAPA GmbH, Zeven (DE)

(21) Appl. No.: 14/950,112

(22) Filed: Nov. 24, 2015

(30) Foreign Application Priority Data
Jan. 9, 2015 (EP) 15 150 663.1-1651

(51) Int. Cl. A61J 11/00; A61J 11/04

(52) U.S. Cl. CPC A61J 11/0015; A61J 11/04

(57) ABSTRACT

A bottle teat, in particular for infants and small children, having a suction part with at least one drinking slit, and a teat flange connected to the bottom end of the suction part for fastening to the front edge of a mouth of a container, wherein the drinking slit is cut by a laser beam in the suction part, and is opened a small gap when the bottle teat is in an unstressed state.

### BACKGROUND OF THE INVENTION

The invention relates to a bottle teat, especially for infants and small children. The bottle teat can in particular be designed as a bottle nipple or a drinking aid (such as a feeding spout or drinking spout) according to European standard EN 14350-1.

Bottle teats are used to administer milk and other liquid food, especially to infants and small children. Bottle teats have a hollow suction part with a through-hole for liquid food. The suction part is integrally connected at the bottom to an annular-disc-shaped teat flange which serves for fastening to the mouth of a container. The container in particular is a drinking bottle (feeding bottle), drinking cup or feeding bag. For fastening to a container, an attachment ring is used which has a cylindrical cover with fastening means for fastening to the fastening means of the container. Generally, the fastening means are threads on the inner circumference of the cover and on the outer circumference of the container. Furthermore, the fastening ring has an inward-projecting, annular-disc-shaped ring flange that overlaps the nipple flange and presses against the front edge of the mouth of the container.

Bottle nipples generally consist of soft elastic material. Drinking aids and drinking spouts are often also made of soft elastic material. However, there are also drinking aids of hard (or respectively hard elastic) plastic, or a combination of hard and soft materials. For example, drinking aids are known that consist of a hard plastic with a valve insert consisting of soft elastic material which is clamped on the edge between the drinking aid and the mouth of the container.

When suction is exerted on the suction part, a vacuum arises in the container which makes it difficult to withdraw the liquid and can cause a soft elastic bottle teat to collapse. To prevent this, bottle teats have a ventilation valve. The ventilation valve opens to equalize pressure with the surroundings when a certain vacuum predominates in the container.

Bottle teats are known in which the through-hole comprises one or more circular drinking holes. The drinking holes are for example produced by means of a correspondingly shaped injection mould or dipping mould, by stamping or penetration with needles, or by drilling with a steel drill, water jet or laser beam. The production of drinking holes by means of a laser beam is described in U.S. Pat. No. 6,032,810A and U.S. Pat. No. 4,623,069A.

FR 2 302 724 A describes a bottle teat which has microperforations whose number and diameter are determined depending on the volumetric flow to be achieved. The microperforations can be produced by means of a laser, ultrasound, or any other technique such as mechanical, chemical or other methods. In two embodiments, the microperforations are formed in a vertical section through the wall of the bottle teat by even or uneven branches that terminate in the outside of a suction part, wherein a plurality of branches are supplied by a single channel which terminates at the inside of the section part. The branching and curved microperforations cannot be produced by means of a straight laser beam.

Drinking holes are so small that no noteworthy amount of liquid exits unintentionally. Due to their small size, high suction pressure must be exerted to withdraw a greater amount of liquid.

If the drinking holes are designed too large, the liquid can flow through unhindered without the child performing any suction work. Consequently, the child does not become familiarized with feeding, and the food can spill. Feeding is furthermore restricted by the vent valve which limits the pressure compensation.

Furthermore, bottle teats are known in which the through-holes are designed as drinking slits. Such bottle teats are for example described in EP 1 924 234 B1 and EP 2 182 910 B1. Both patent publications describe bottle teats with two drinking slits that are parallel to each other. Bottle teats are also known with two intersecting drinking slits. When suction is not exerted on the suction part, the edges of the drinking slits lie against each other in a sealing manner. During suction, the drinking slits open so that liquid can exit. Conventionally, the drinking slits are cut with a knife. Conventional bottle teats with drinking slits are reliably leak-proof and enable a high flow of liquid food. Production is, however, involved. Furthermore, the cut surfaces of the drinking slits tend to adhere and then require high opening pressure. It is also disadvantageous that the drinking slits can tear at the end, thus rendering the bottle teat useless.

### BRIEF SUMMARY OF THE INVENTION

Against this background, an objective of the invention is to create a bottle teat which seals reliably, enables a high flow of liquid food, and has more favourable production features.

The bottle teat according to the invention, in particular for infants and small children, has a suction part with at least one drinking slit, and a teat flange connected to the bottom end of the suction part for fastening to the front edge of a mouth of a container, characterized in that the drinking slit is cut by a laser beam in the suction part, and a small gap is open when the bottle teat is in an unstressed state.

The bottle teat according to the invention has at least one drinking slit which is cut in the suction part by a laser beam. By cutting with the laser beam, a small gap is opened in the drinking slit even without suction on the suction part, i.e., in the unstressed state of the bottle teat. However, the gap width of the gap is kept low enough to achieve a seal of the bottle teat from the capillary effect and surface tension of the cut surfaces sufficient enough to prevent liquid food from unintentionally exiting. The precise production of drinking slits and a sufficiently small gap width is possible by means of a laser beam. The drinking slit enables high amounts of liquid food to exit from sucking on the suction part. For production, it is advantageous that the drinking slit can be generated without contact by the laser beam which permits high production speeds. It is additionally advantageous that production by the laser beam enables any desired drinking slit contours. An additional advantage is that the ends of the drinking slit produced by a laser beam tend to tear less than when produced by a knife since the ends are rounded by the laser beam and tend to tear less.

According to one embodiment of the invention, the gap width of the drinking slit is at least 0.1 mm, preferably at least 0.2 mm and/or a maximum of 0.4 mm, and preferably a maximum of 0.3 mm. The gap widths are easily producible with a laser beam and prevent the unintentional drainage of liquid food.

According to another embodiment, the radius of the rounded ends of the drinking slit is the same as or exceeds the gap width of the drinking slit. When the radius of the rounded ends corresponds to the gap width, the unintentional discharge of liquid is counteracted in a particularly effective manner. It is, however, also possible in principle for the radius of the rounded ends to exceed the gap width. The latter can be achieved by the laser beam dwelling at the ends for a short time, or correspondingly controlling the guidance of the cutting with the laser beam. The larger radii can better prevent tearing.

The drinking slit can have any shape, in particular a straight or zigzag shape, or a curved shape (such as a C shape). Furthermore, the bottle teat can have a plurality of drinking slits with the same or different shapes. In addition, the invention enables the shape of the drinking slit to be easily changed, and the production of different batches with different drinking slits, or even of different drinking slits within individual batches, is facilitated.

According to another embodiment, the bottle teat has a plurality of drinking slits that are connected to each other and have a branching path. With a bottle teat according to the invention, the branching path extends in the surface of the suction part and not perpendicular to the surface as is the case with drinking holes according to FR 2 302 724 A1. This embodiment enables a bottle teat with drinking slits which only open a very small gap by means of which the desired seal of the bottle teat is achieved. At the same time, the branching drinking slits provide a sufficiently large opening during sucking for the desired volumetric flow to exit.

According to another embodiment, the drinking slits have a branching path corresponding to the milk ducts of the nipple. In this embodiment, the drinking slits have bionic contours which enable natural nursing to be approximated.

According to one embodiment, the bottle teat has a plurality of drinking slits connected to each other which have a common interface and extend in different directions. This embodiment is also good for a bottle teat with drinking slits that are only opened a very small gap when suction is not being exerted on the suction part so that they have the desired seal. At the same time, the drinking slits provide a sufficiently large opening during sucking for the desired volumetric flow to exit. Drinking slits with a common interface can be combined with drinking slits having a branching path.

According to one embodiment, the bottle teat has drinking slits which extend away from the interface on both sides. These are drinking slits that are for example arranged in the shape of a cross, or respectively an X. According to another embodiment, the bottle teat has drinking slits which each only extend away from the common interface on one side. These are for example three drinking slits arranged in the shape of a Y.

According to another embodiment, the bottle teat has a plurality of arrangements, each consisting of a plurality of drinking slits connected to each other. In this embodiment, the slit width can be further reduced to increase the seal of the bottle teat, and the desired volumetric flow can nevertheless be ensured while suction is exerted on the bottle teat.

According to another embodiment, the bottle teat additionally has one or more drinking holes. The drinking holes are for example arranged symmetrically on different sides of a drinking slit, or one or more arrangements consisting of different drinking slits. The drinking holes can for example be circular or oval. Furthermore, the suction part can have a plurality of drinking holes with different dimensions (diameters). The drinking holes are preferably produced by means of a laser beam in the suction part. Alternatively, they are for example produced in the suction part by means of a correspondingly shaped injection mould or dipping mould, by stamping or penetration with needles, or by drilling with a steel drill or water jet.

According to another embodiment, the bottle teat consists entirely or partially of soft elastic material. The bottle teat preferably consists of soft elastic material, in particular when the bottle teat is intended for infants and small children. Preferably, the teat flange also consists of soft elastic material in order to achieve a particularly good seal at the mouth of a container. In particular when designed as a bottle nipple or a drinking aid, the entire bottle nipple consists of soft elastic material.

According to a preferred embodiment, the bottle teat is produced entirely or partially from one or a combination of the following materials: Silicone, latex and thermoplastic elastomer. The cited materials are soft elastic materials according to the invention.

According to another embodiment, the bottle teat consists entirely or partially of a hard, or respectively hard elastic plastic, or another hard, or respectively hard elastic material. In particular when designed as a drinking aid (such as a drinking sleeve or drinking spout), the bottle teat can consist entirely or partially of hard elastic, or hard material.

According to another embodiment, the bottle teat is injection moulded or dipped. It is preferably injection moulded when realised from silicone, thermoplastic elastomer or respectively hard elastic plastic, and preferably dipped when realised from latex.

According to another embodiment, the at least one drinking slit is arranged at a sharp angle relative to the mid-axis through the teat flange. This is advantageous for sealing the drinking slit by means of a cap (rinsing cup) which is held on a fastening ring for fastening the bottle teat to a container.

According to another embodiment, the bottle teat is attached by means a of fastening ring to the mouth of a container. According to another embodiment, the fastening ring has fastening means, and the container has additional fastening means that are connected to each other to fasten the bottle teat to the container. According to another embodiment, a ring flange of the fastening ring presses against the top side of the teat flange, and the bottom side of the teat flange against the edge of the mouth of the container so that the teat flange is fixed between the fastening ring and the mouth of the container. According to another embodiment, the fastening means are an inner thread on the fastening ring and an outer thread on the container.

According to another embodiment, the bottle teat is covered by a cap held on the fastening ring. This protects the bottle teat from contaminants.

According to another embodiment, a floor wall and/or a side wall of the cap lies sealing against the edge of the drinking slit. This protects the bottle teat from unintentionally leaking liquid, for example when the container is stored with the bottle teat facing downward. This embodiment can in particular be designed as described in European patent EP 2 299 965 B1 whose description is included in the present application by way of reference.

According to another embodiment, the bottle teat is a bottle nipple, a feeding spout, or a drinking spout.

According to another embodiment, the bottle teat is fastened to a container that is a feeding bottle, a drinking cup or a feeding bag.

Furthermore, the objective is achieved with an additional bottle teat according to the invention having the following features:

The bottle teat, especially for infants and small children, has a suction part with at least two intersecting drinking slits and a teat flange connected to the bottom edge of the suction part for fastening to a front edge of a mouth of a container, characterized in that a hinge extends, at a distance from the interface of the two drinking slits, from one drinking slit to the other drinking slit.

With the bottle teat according to the invention, the two drinking slits are closed when suction is not being exerted on the suction part. When suction is being exerted on the suction part, the area between the neighbouring drinking slits can be folded, or respectively bent around the hinge, which facilitates the opening of the drinking slits. The hinge and the two drinking slits accordingly delimit a valve with a valve flap which is elastically deflectable from the sealed position in order to release an opening in the suction part. This invention enables bottle teats which seal well when suction is not being exerted on the suction part and that are easily permeable when suction is being exerted on the suction part. The drinking slits can be cut in a conventional manner with a knife. According to an alternative embodiment, the drinking slits are cut into the suction part with a laser beam. According to other embodiments, the bottle teat with the hinge between the drinking slits additionally has the features of one or more of claims 1 to 18 of the present application.

According to one embodiment, the hinge is formed by a thinning of the wall thickness in the suction part.

According to another embodiment, the thinning of the wall thickness is a recess in the outside, and/or in the inside of the suction part. Alternatively, the thinning of the wall thickness is at least one incision in the outside and/or the inside of the suction part. The incision is for example an uninterrupted incision which only partially cuts through the wall of the suction part. Alternatively, the drinking slit is the result of small slits that completely penetrate the wall of the suction part.

According to a preferred embodiment, the recess is formed by injection moulding the bottle teat using a suitable injection mould, or by dipping the bottle teat using a suitable dipping tool. According to a different embodiment, the thinning of the wall thickness is created by laser beams.

According to another embodiment, the two ends of the hinge are each a short distance from the neighbouring drinking slit. This counteracts the valve area delimited by the hinge and the two drinking slits in the valve area from tearing off.

According to another embodiment, the drinking slits intersect, and the hinges are arranged between neighbouring sections of the drinking slits. Preferably, hinges are arranged on different sides of the interface between the drinking slits. For example, two or four hinges are arranged around the interface.

According to another embodiment, the hinge is arranged between the ends of the drinking slits distant from the insertion point. This yields drinking slits that open particularly easily.

According to another embodiment, the two drinking slits are connected to each other by a third drinking slit, and the hinge extends from the first drinking slit to the second drinking slit at a distance from the third drinking slit. As a result, the bottle teat releases a particularly large drinking opening in response to suction.

Finally, more than two drinking slits are connected to each other according to one embodiment, wherein the drinking slits have a branching geometric structure, and the hinges extend between the drinking slits which form neighbouring branches of the branching. The drinking slits open particularly wide in response to suction. In this embodiment, the drinking slits are preferably created with laser beams. It is, however, also possible to produce the drinking slits with knives for cutting, or in another known manner.

### BRIEF DESCRIPTION OF THE SEVERAL VIEWS OF THE DRAWINGS

The invention will be further explained below with reference to the accompanying drawings of exemplary embodiments. The drawings show:

FIG. 1 a partial vertical section of a bottle teat with a fastening ring and a top cap on a container;

FIG. 2 an enlarged view of the drinking slits of the bottle teat diagonally from above and from the side;

FIG. 3 shows an alternative embodiment of the drinking slits;

FIG. 4 shows an additional alternative embodiment of the drinking slits;

FIG. 5 shows an additional alternative embodiment of the drinking slits;

FIG. 6 shows highly enlarged milk ducts of a nipple in a microscopic image;

FIG. 7-10 show different alternative embodiments of the drinking slits;

FIG. 11 shows a conventional drinking hole;

FIG. 12-13 shows different additional alternative embodiments with drinking slits;

FIG. 14 shows an embodiment of the drinking slits with additional hinges; and

FIG. 15 shows an enlarged partial section of the same embodiments during the application of suction pressure.

### DETAILED DESCRIPTION OF THE INVENTION

While this invention may be embodied in many different forms, there are described in detail herein a specific preferred embodiment of the invention. This description is an exemplification of the principles of the invention and is not intended to limit the invention to the particular embodiment illustrated.

In the present application, the terms “top” and “bottom” refer to an arrangement of the bottle teat in which the suction part is above the teat flange when the teat flange is horizontally aligned.

The bottle teat 1 has a suction part 2 which is connected at the bottom to an annular-shaped teat flange 3. The bottle teat 2 has a bellows-like nipple sleeve 4 that narrows upward from a large diameter 5. At the bottom, the nipple sleeve 4 has a constriction 6. At the bottom end of the constriction 6, the nipple sleeve 4 is connected to an annular-shaped nipple flange 3 projecting radially outward that surrounds a mid-axis 7.

At the top, the nipple sleeve 4 bears a nipple 8 that has a nipple neck 9 and a nipple head 10. The nipple head 10 is provided with a bevel 11 that is at an angle to the mid-axis 7 3 and is basically flat but slightly dented inward. On the opposite side, the nipple head 9 has two drinking slits 12.1, 12.2 for the passage of liquid food which intersect according to FIG. 2. The drinking slits 12.1, 12.2 each have rounded ends 13.1, 13.2 and 14.1, 14.2. They are cut into the suction part 2 with a laser beam so that each drinking slit 12.1, 12.2 has a gap width 5 of 0.1 to 0.4 mm, and preferably 0.2 to 0.3 mm. The radius R of the rounded ends 13.1, 13.2, 14.1, 14.2 corresponds to the gap width S of the respective drinking slit.

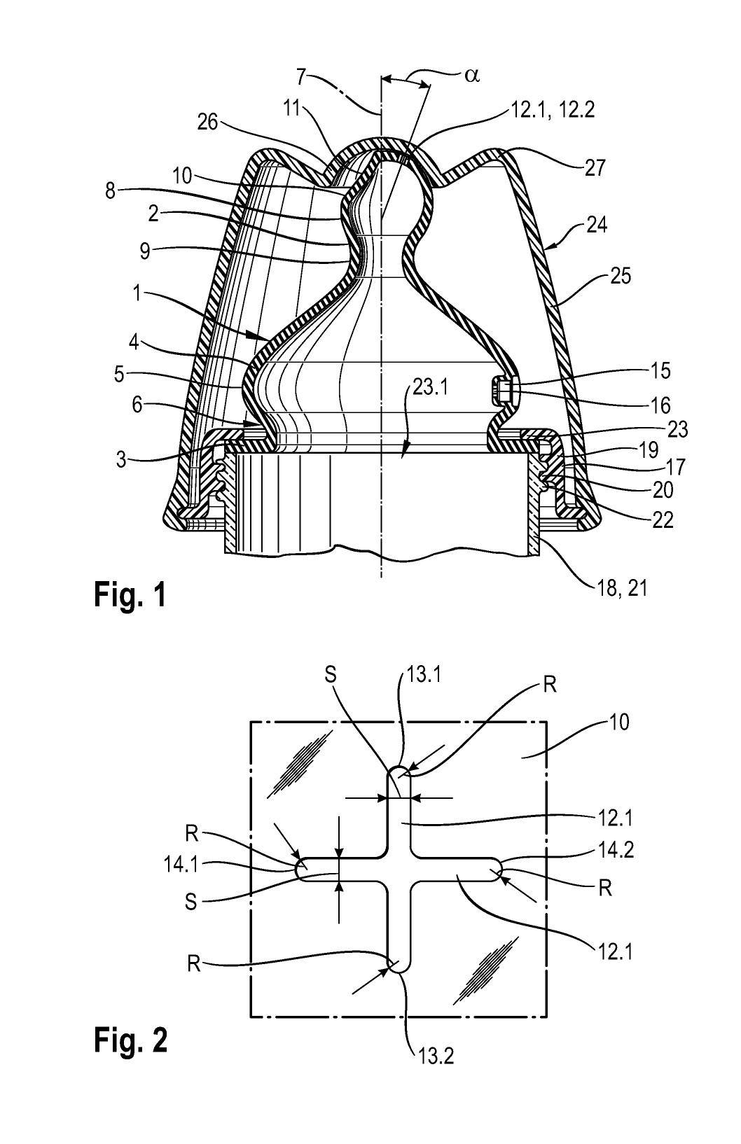

According to FIG. 1, the drinking slits 12.1, 12.2 are aligned at an angle α of for example 30° to the mid-axis 7.

Furthermore, the area of the largest diameter 5 of the bottle teat 1 has a recess 15 in the floor of which a vent valve is arranged. The vent valve 16 is designed as a slit valve 16, preferably with two intersecting vent slits. The vent slits are created with knives or also with a laser beam.

In the example, the bottle teat 1 is a bottle nipple. It is preferably produced as a single part from a soft elastic material such as silicone, thermoplastic elastomer or latex.

According to FIG. 1, the bottle teat 1 is affixed to a container 18 by means of a fastening ring 17. The fastening ring 17 has an inner thread 20 on the inner circumference of its approximately cylindrical cover 18. On the outer circumference of its neck 21, the container 18 has an outer thread 22 so that the fastening ring 17 can be screwed onto the container 18. On the top edge, the fastening ring 17 has an inward-projecting ring flange 23 which engages in the constriction 6 of the bottle teat 1.

The ring flange 23 presses against the top side of the bottle teat 3 and thereby presses its bottom side against the flat face edge of a mouth 23 of the container 18.

Furthermore, the arrangement comprises a cap 24 which has a slightly conical sidewall 25 which is placed on the bottom edge on the fastening ring 17. The cap 24 has an inwardly curved dome-shaped floor 26. The transition area of the floor 26 to the conical sidewall 25 has a rounding 27. The dome-shaped floor 26 is symmetrical relative to the mid-axis 7. The rounding 27 runs around the mid-axis 7. When the cap 24 is placed on the fastening ring 17, the dome-shaped floor 26 presses against the side surface of the nipple head 10 facing away from the mid-axis 7.

The drinking slits 12.1, 12.2 are arranged in the nipple head such that edge areas of the drinking slits 12.1, 12.2 press sealingly against the floor 26 of the cap 24.

Producing the drinking slits 12.1, 12.2 with laser beams is good for fast and precise mass production with any drinking slit 12.1, 12.2 geometry. Unintentional leakage of liquid is suppressed by the capillary effect and surface tension of the cut surfaces that delimit the drinking slits 12.1, 12.2.

The gap existing from the beginning prevents the cut surfaces of the drinking slits 12.1, 12.2 from adhering and prevents a correspondingly elevated opening pressure. A tearing of the drinking slits 12.1, 12.2 is prevented by the rounded ends 13.1 to 14.2.

It is particularly advantageous that producing the drinking slits 12.1, 12.2 with a laser beam enables any desired geometries.

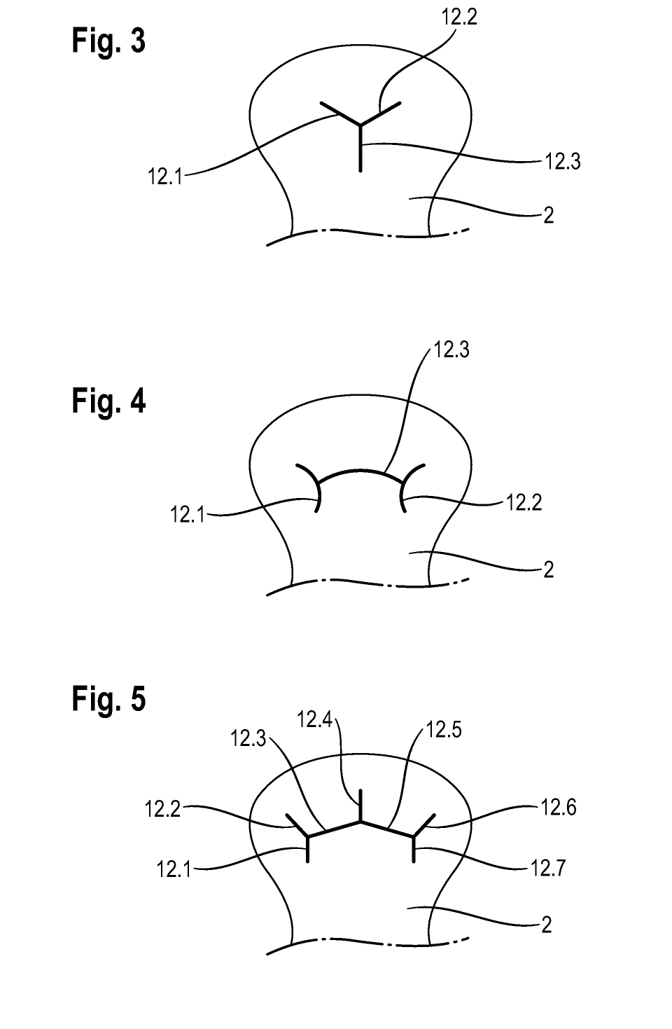

In the embodiment in FIG. 3, the suction part 2 has three drinking slits 12.1, 12.2, 12.3 in a Y or respectively star-shaped arrangement. The angle between neighbouring drinking slits is for example 120° in each case.

In the embodiment in FIG. 4, the suction part 2 has three drinking slits 12.1, 12.2, 12.3 which are each curved, wherein there are two lateral drinking slits 12.1, 12.2, and a middle drinking slit 12.3 extends from one lateral drinking slit 12.1, 12.2 to the other.

In the embodiment in FIG. 5, the suction part 2 has seven drinking slits 12.1 to 12.7 that are connected to each other and have a branching geometric arrangement. The arrangement of the drinking slits 12.1 to 12.7 is similar to the geometry of the milk ducts in the nipple shown in FIG. 6. The geometry of the drinking slits can further approximate the geometry of the milk ducts 28 of the nipple. It is also possible to provide the bottle teat with a number of arrangements consisting of a plurality of drinking slits which approximate the milk ducts of the nipple. This yields a bionic bottle teat.

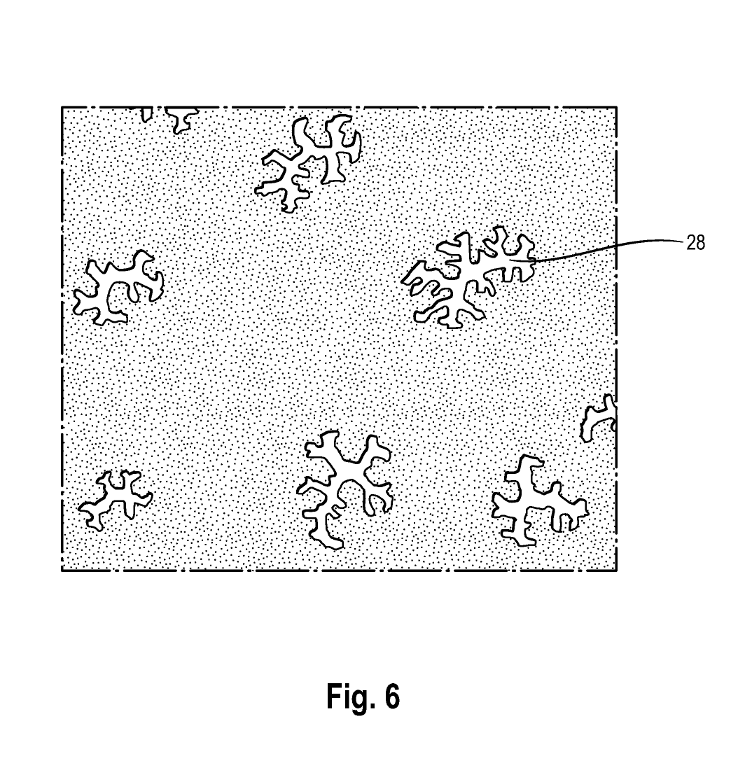

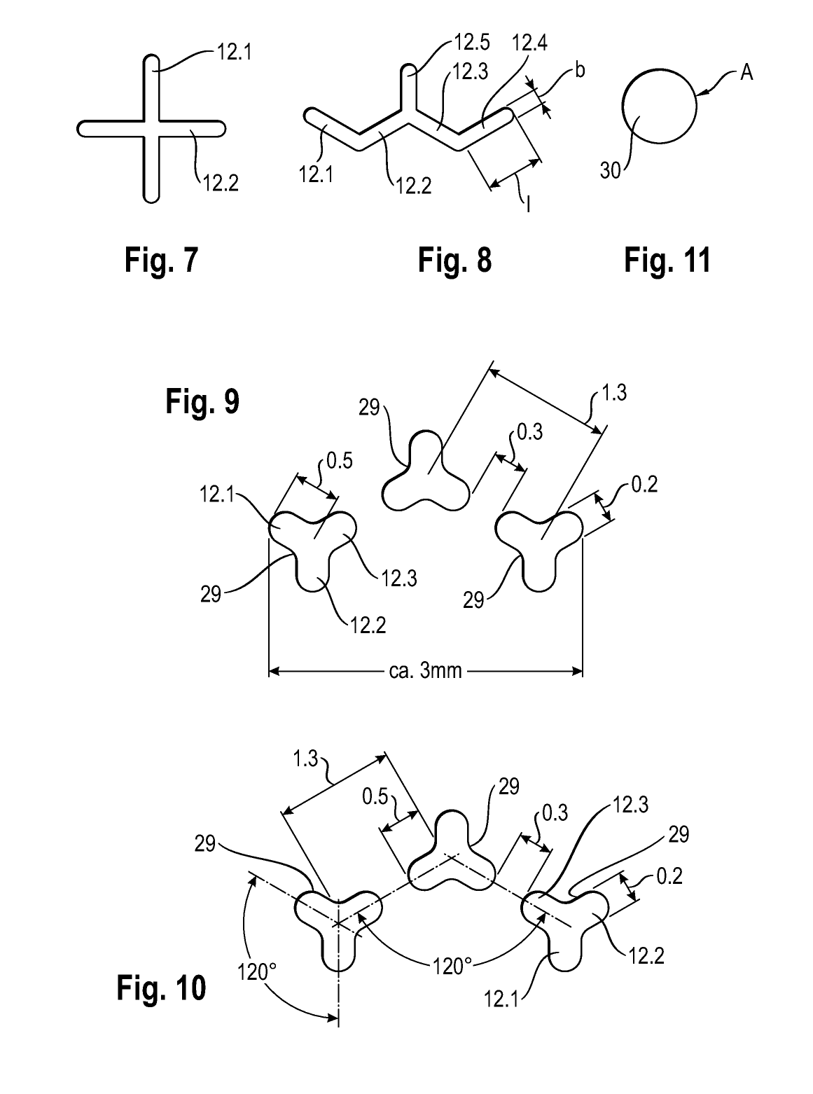

FIGS. 7 to 10 show different alternative drinking slit geometries with dimensional information. The dimensions are selected so that the opening cross sections of the different drinking slit geometries are equivalent in a non-stressed state. This illustrates that the drinking slits according to the invention prevent the undesirable discharge of liquid better than a conventional drinking hole. The drinking slit geometries according to the invention do not require the same cross-section, however. In the example, the opening cross section has an area of 1.54 mm² The associated dimensions of the drinking slits are indicated in the relevant drawing.

FIG. 7 shows a drinking slit geometry consisting of two intersecting drinking slits 12.1 and 12.2.

FIG. 8 shows a drinking slit geometry consisting of five drinking slits 12.1 to 12.5 with a branching path. Four drinking slits 12.1 to 12.4 are arranged in a W-shape, and an additional drinking slit 12.5 extends upward from the intersection of the two middle drinking slits 12.2, 12.3.

FIGS. 9 and 10 each show an arrangement consisting of three star-shaped drinking slit geometries 29, wherein each star-shaped drinking slit geometry 29 consists of three drinking slits 12.1, 12.2, 12.3. The star-shaped drinking slit geometries 29 are arranged such that in each case two neighbouring drinking slits 12.1, 12.2, or respectively 12.2, 12.3, or respectively 12.3, 12.1 of different star-shaped drinking slit geometries 29 are aligned with each other. This drinking slit arrangement is shown in two figures (FIGS. 9 and 10) in order to present the dimensions more clearly.

As a comparison, FIG. 11 shows a conventional circular drinking hole which also has an opening cross-section of 1.5 mm² The comparison illustrates that due to its large diameter, the conventional drinking hole facilitates an undesirable discharge of liquid, whereas the drinking slits 12.1, 12.2, 12.3 according to the invention prevent undesired discharge of liquid due to the narrower slit width with the same cross-section.

The smaller opening width of the drinking slits 12.1, 12.2, 12.3 according to the invention promotes the retention of liquid from surface tension and prevents the undesired spilling of liquid (non-spill effect). Furthermore, the drinking slits 12.1, 12.2, 12.3 according to the invention can open wider when suction is exerted on the bottle teat due to the forces acting on the edges of the slits when liquid is flowing out, and a greater opening cross-section is therefore provided for the discharge of liquid.

The above-cited opening cross section in exemplary embodiments FIGS. 7 to 10 is only an example. Depending on the media to be administered, other cross-sections can be chosen.

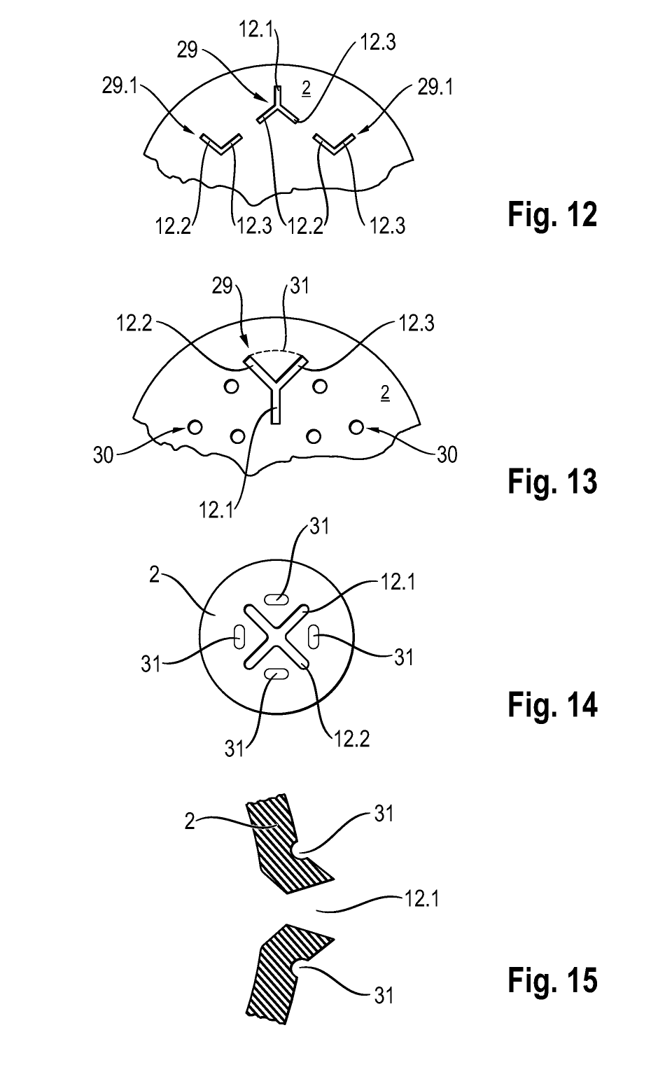

FIGS. 12 and 13 show an enlarged, plan view of other arrangements of drinking slits. The arrangement in FIG. 12 substantially corresponds to the arrangement in FIG. 9. In correspondence with this arrangement, the arrangement in FIG. 12 has a star-shaped drinking slit geometry 29 in the middle consisting of three drinking slits 12.1, 12.2, 12.3. In contrast to FIG. 9, there are arrangements 29.1 on both sides of the middle arrangement 29 which each comprise only two drinking slits 12.2 and 12.3, i.e., not drinking slit 12.1.

According to FIG. 13, there is only one middle drinking slit geometry 29 consisting of three drinking slits 12.1, 12.2, 12.3. In the example, the drinking slit geometry 29 is T-shaped. Drinking holes 30 are arranged on both sides of the drinking slit geometry 29. In the example, the drinking holes 30 are arranged symmetrically on both sides of the drinking slit geometry 29. In the example, this is shown with respect to arrangements of three drinking holes 30 each on each side of the drinking slit geometry 29.

In addition, there is a hinge 31 in FIG. 13 between the ends of the drinking slits 12.2, 12.3 of the drinking slit geometry 29. The hinge 31 is for example formed by a thinning of the wall thickness on the outside or the inside of the suction part.

According to FIGS. 14 and 15, a cross-shaped arrangement of drinking slits 12.1, 12.2 is additionally provided with hinges 31. The hinges 31 extend between the ends of neighbouring sections of the drinking slits 12.1, 12.2. They each end a distance from the ends of the drinking slits.

The hinges 31 are formed by notches or recesses in the outside or inside of the suction part 2. In the example, they are formed in the outside.

According to FIG. 14, the area between the neighbouring drinking slits 12.1, 12.2 can bend outward more easily during sucking as a result of the hinges 31, and a particularly large drinking opening is therefore released.

This completes the description of the preferred and alternate embodiments of the invention. Those skilled in the art may recognize other equivalents to the specific embodiment described herein which equivalents are intended to be encompassed by the claims attached hereto.

1. A bottle teat comprising:
a suction part (2) with at least one drinking slit (12.1, 12.2),
a teat flange (3) connected to the bottom end of the suction part (2) for fastening to the front edge of a mouth (23) of a container (18),
wherein the drinking slit (12.1, 12.2) is cut by a laser beam in the suction part (2), and is opened a small gap when the bottle teat (1) is in an unstressed state.

2. The bottle teat according to claim 1, wherein the gap width of the drinking slit (12.1, 12.2) is 0.1 to 0.4 mm, and preferably 0.2 to 0.3 mm.

3. The bottle teat according to claim 1, wherein the ends (13.1 to 14.2) of the drinking slit (12.1, 12.2) are rounded.

4. The bottle teat according to claim 3, wherein the radius of the rounded ends (13.1 to 14.2) is the same or exceeds the gap width of the drinking slit (12.1, 12.2).

5. The bottle teat according to claim 1, wherein a plurality of drinking slits (12.1, 12.2) are connected to each other and have a branching path as a whole.

6. The bottle teat according to claim 5, wherein the drinking slits (12.1, 12.2) have a branching path corresponding to milk ducts (28) of the nipple.

7. The bottle teat according to claim 1, having drinking slits (12.1, 12.2, 12.3) which have a common interface and extend in different directions.

8. The bottle teat according to claim 7, having drinking slits (12.1, 12.2, 12.3) which extend on both sides of the interface, or only on one side of the interface.

9. The bottle teat according to claim 5, having a plurality of arrangements consisting of drinking slits (12.1, 12.2, 12.3) connected to each other.

10. The bottle teat according to claim 1, consisting entirely or partially of a soft elastic material.

11. The bottle teat according to claim 1, consisting entirely or partially of a hard elastic plastic or another hard plastic material.

12. The bottle teat according to claim 1, wherein the at least one drinking slit (12.1, 12.2) is arranged at a sharp angle relative to the mid-axis (7) through the teat flange (3).

13. The bottle teat according to claim 1, attached by a fastening ring (17) to the mouth (23) of a container (18).

14. The bottle teat according to claim 13, including a cap (24) held on the fastening ring (17), and wherein a floor (26) and/or a side wall (24) of the cap (24) lies sealingly against the edge of the drinking slit (12.1, 12.2).

15. The bottle teat according to claim 1, wherein the bottle teat is a bottle nipple or a feeding spout or a drinking spout.
